(19) United States
(12) Patent Application Publication
(10) Pub. No.: US 2018/0310530 A1
(43) Pub. Date: Nov. 1, 2018

(54) Chicken House with Protected Grazing Area

(71) Applicants: Alan Wayne Lockstedt, Magnolia, TX (US); Jan Hebert Lockstedt, Magnolia, TX (US)

(72) Inventors: Alan Wayne Lockstedt, Magnolia, TX (US); Jan Hebert Lockstedt, Magnolia, TX (US)

(21) Appl. No.: 15/497,411

(22) Filed: Apr. 26, 2017

(51) Int. Cl. A01K 31/18; A01K 31/00

(52) U.S. Cl. CPC A01K 31/18; A01K 31/002

(57) ABSTRACT

A poultry house habitat with a discrete natural environment enclosure which protects poultry while granting them freedom to move during their normal egg-laying period and a cage area structure with cubbyholes in which to sleep. The attached enclosed grazing area allows the poultry to maintain a more complete diet by supplementing normal feed with insects, grass, and soil. Because the poultry have greater freedom of movement and a more complete diet, the resulting eggs and meat are of a much higher nutritional quality and have a better taste.

### CROSS-REFERENCE TO RELATED APPLICATION

This application claims the benefit of U.S. provisional application No. 62/496,181, filed Oct. 11, 2016, which application is fully incorporated herein by reference.

### BACKGROUND INFORMATION

The present invention is in the technical field of poultry husbandry and, more particularly, in the technical subfield of poultry housing. It allows for a more natural lifestyle for the birds, which in turn produces higher-quality eggs and meat. Most poultry housing provides birds with very little space (often less than one square foot per bird), including little to no access to the natural environment where the birds can acquire valuable nutrients from consuming vegetation, insects, and soil. The eggs and meat produced from these confining habitats are generally of lower nutritional quality and poorer taste.

Typical small-scale poultry housing has run areas, which are open and put the birds in danger of possible predators able to fly, climb, or jump into the area and attack the birds.

### BRIEF SUMMARY OF THE INVENTION

The present invention is an egg-production poultry house which provides a large, enclosed natural environment suitable to allowing poultry to freely graze and maintain a more complete and sustainable diet based on not only poultry feed, but vegetation, insects, and soil. It is primarily designed to accommodate the habits of chickens, but can be easily utilized for other poultry. The chickens are contained in the cage and yard areas during roosting/egg-laying period (sunset until two to three hours before sunset the following day). The chickens lay eggs from sunrise until early afternoon, and the cage and yard areas provide security for the chickens while also keeping them contained in a small enough area to facilitate easy egg collection. Following this period, the grazing area is opened for two to three hours to allow the chickens to graze naturally before sunset. Once the sun begins to set, the chickens instinctively return to the cage area to roost for the evening and the grazing area gate should be closed.

### BRIEF DESCRIPTION OF THE DRAWINGS

FIG. 1 is a top-down view of the entire chicken house, the cage area, the yard area, and grazing area.

FIG. 2 is an isometric view of the entire chicken house, the cage area, the yard area, and grazing area with a different possible configuration for the grazing area.

FIG. 3 is a top-down view of the entire chicken house, the cage area, the yard area, and grazing area.

FIG. 4 is an isometric view of the entire chicken house, the cage area, the yard area, and grazing area with a different possible configuration for the grazing area.

FIG. 5 is a side view of the entire chicken house, the cage area, the yard area, and grazing area as depicted in FIG. 2.

FIG. 6 is a side view of the entire chicken house, the cage area, the yard area, and grazing area as depicted in FIG. 4.

### DETAILED DESCRIPTION OF THE INVENTION

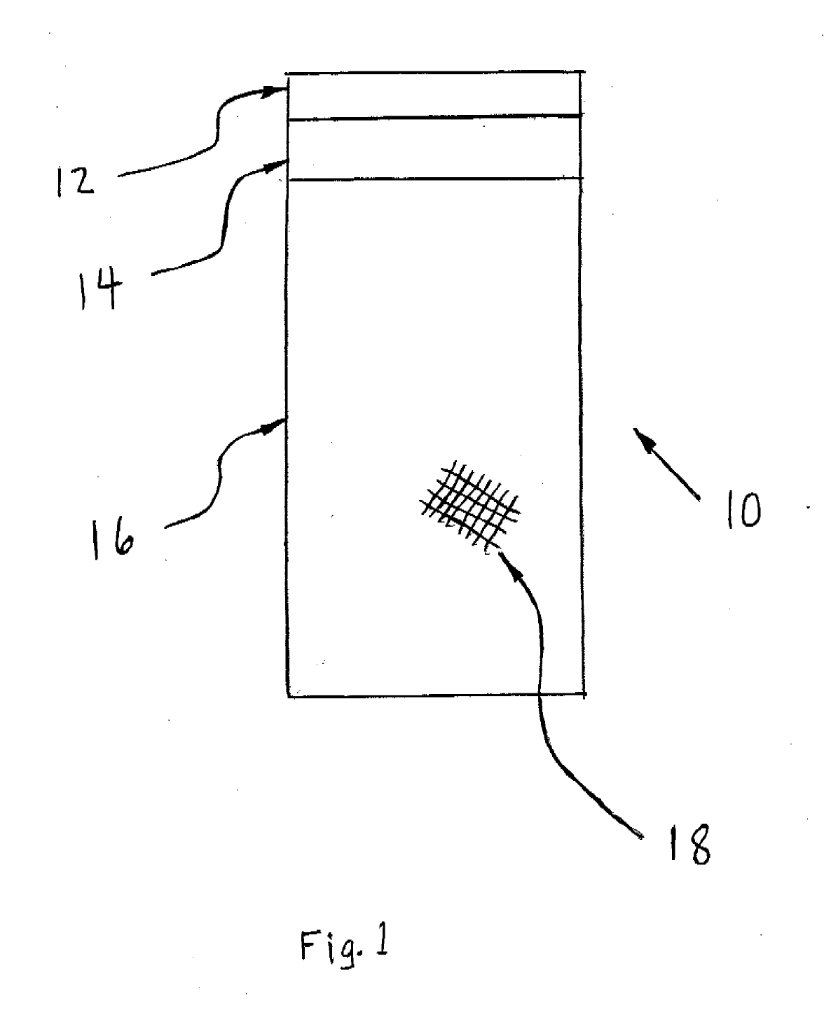

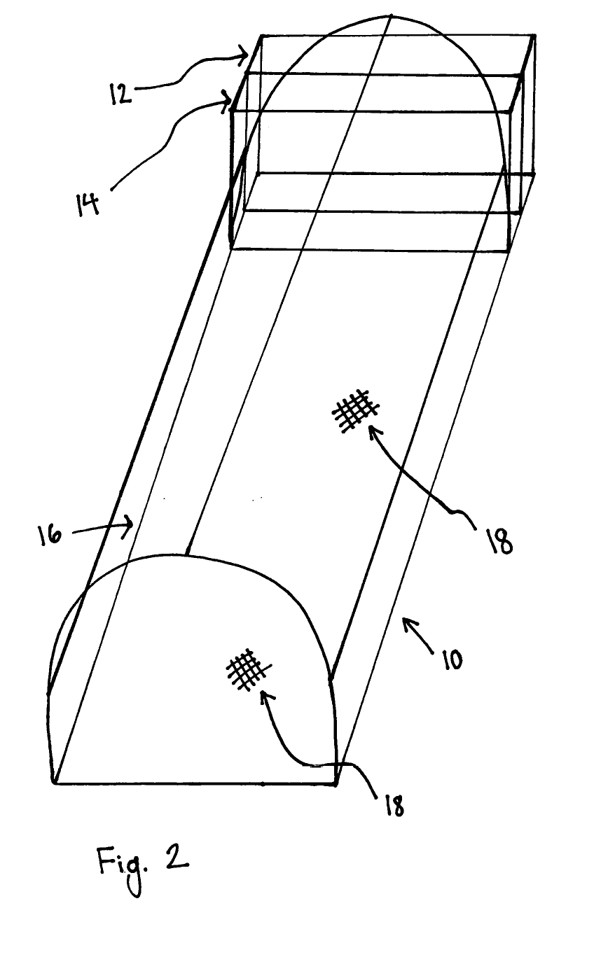

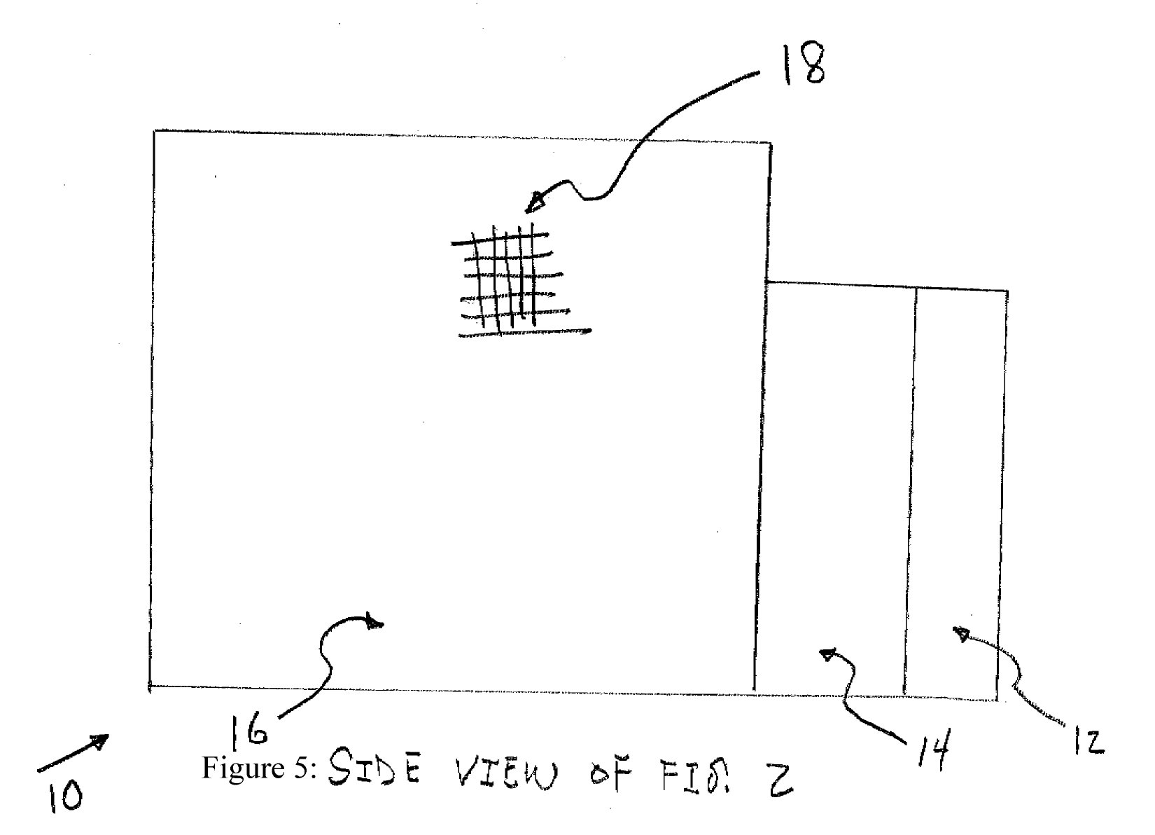

Referring now to the invention in more detail, FIGS. 1, 2, and 5 depict the whole chicken house invention, marked as 10. The cage area is marked 12, the yard area 14, and the grazing area 16. The grazing area 16 is enclosed with a screen or mesh material 18.

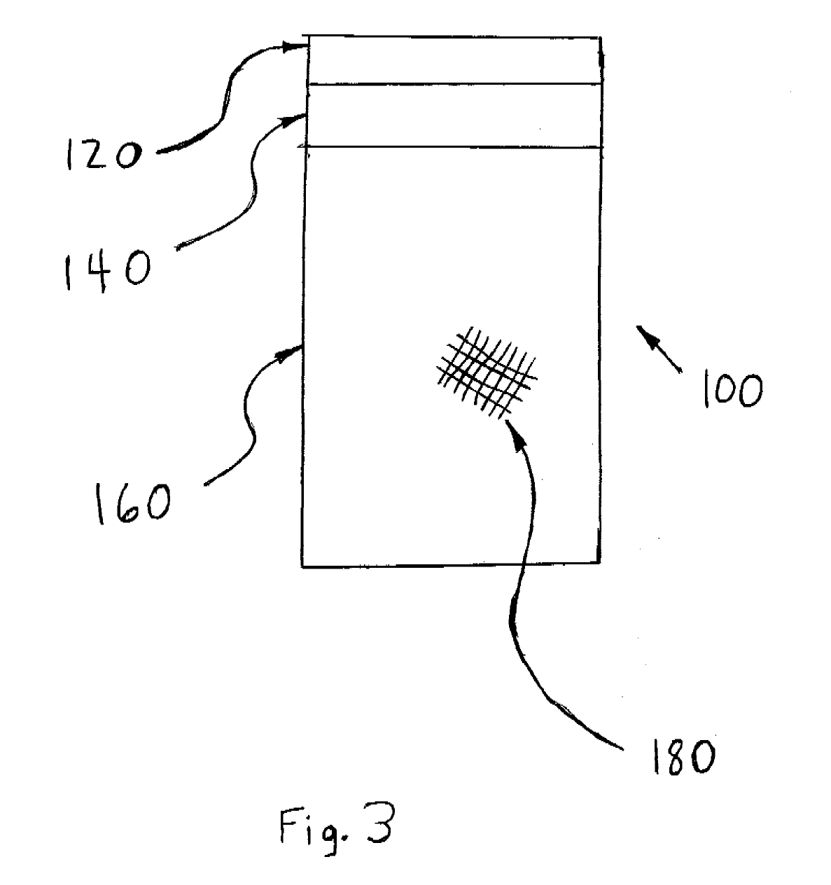

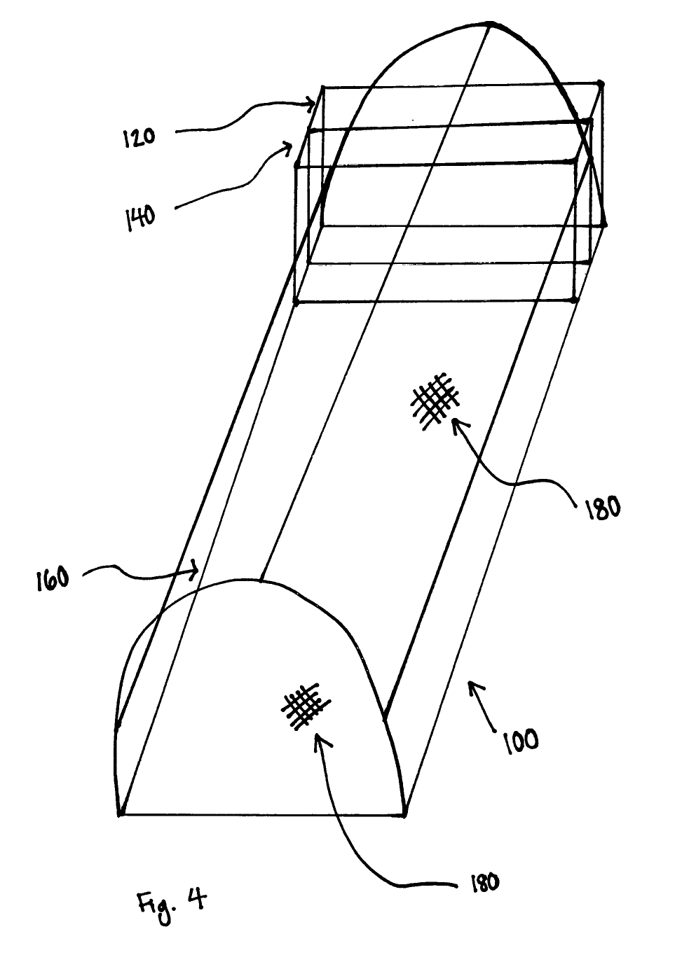

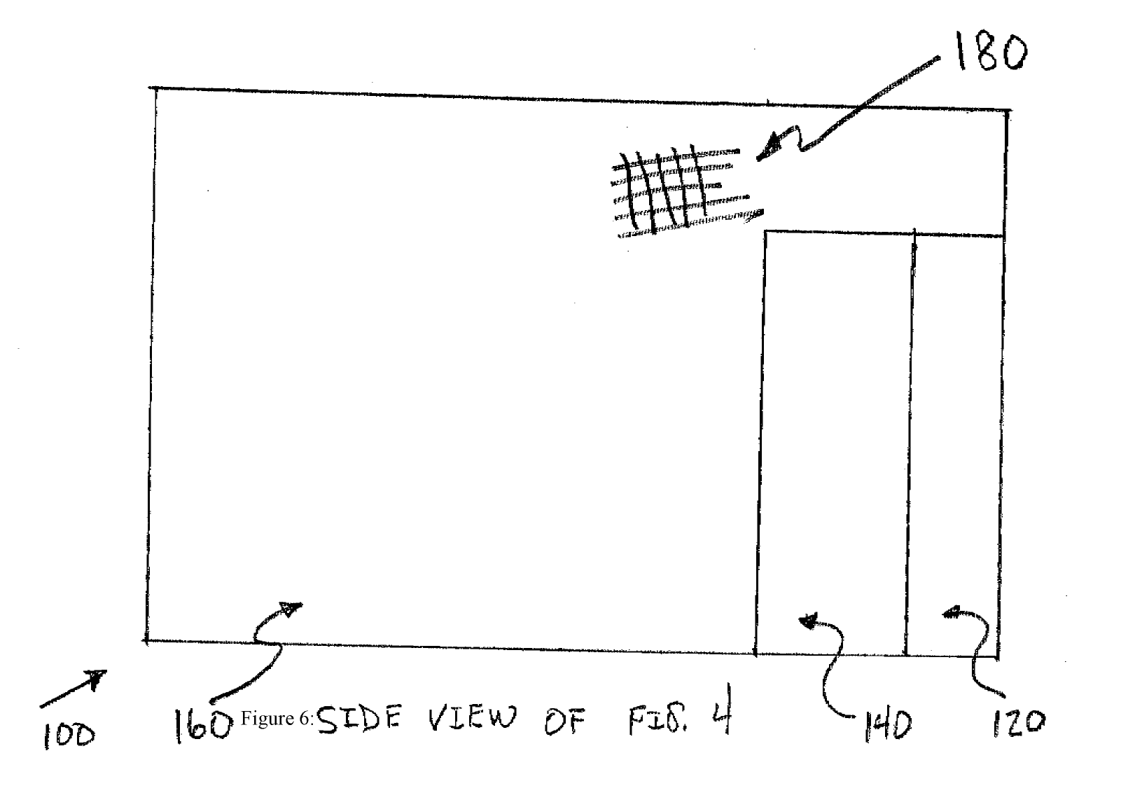

FIGS. 3, 4, and 6 depict the whole chicken house invention, marked as 100. The cage area is marked 120, the yard area 140, and the grazing area 160. The grazing area 160 is enclosed with a screen or mesh material 180.

The cage area 12 or 120 has an approximate area of one to four square feet per chicken. The yard area 14 or 140 has an approximate area of ten to fifteen square feet per chicken. The grazing area 16 or 160 has an approximate area of sixty to one hundred square feet per chicken.

The cage area 12 or 120 is constructed with metal, wood, or plastic as a standing structure. It contains cubbyholes in which the chickens can lay eggs or roost for the night. The floor of this area is made of screen or mesh material 18 to ease removal of excrement.

The yard area 14 or 140 is constructed with a metal, wood, or plastic frame placed in the ground and is covered with screen or mesh material 18 or 180. The screen or mesh material 18 or 180 must be secured to the ground to prevent predators from entering.

The grazing area 16 or 160 is constructed with a metal, wood, or plastic frame placed in the ground and is covered with screen or mesh material 18 or 180. The screen or mesh material 18 or 180 must be secured to the ground to prevent predators from entering. There is a gate between grazing area 16 or 160 and the yard area 14 or 140 made from the screen or mesh material 18 or 180.

The screen or mesh material 18 or 180 should be made of metal wire, fiberglass, or other synthetic material

While the foregoing written description of the invention enables one of ordinary skill to make and use what is presently considered to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

1-5. (canceled)

6. A chicken house comprising
a cage;
a yard area connected to the cage; and
a grazing area;
wherein the cage, yard area, and grazing area have sides and a top;
wherein the sides and top of the yard area and grazing area consists of wire or mesh material on a frame, said wire or mesh material also secured to the ground upon which chicken house sits;
wherein the bottom of the yard area and grazing area is open to the surface of the ground upon which the chicken house sits
wherein one side of the cage is connected to one side of the yard area allowing for unrestricted passage between the cage and yard area;
wherein one side of the yard area contains a gate;
wherein the grazing area is connected to the yard area in such a way that the grazing area is accessible via the gate on one side of the yard area.

7. The chicken house of claim 6 wherein one side of the grazing area is connected to one side of the yard area, with a gate allowing passage between the yard area and the grazing area.

8. The chicken house of claim 6 wherein the cage and yard area are enclosed within the grazing area.

9. The chicken house of claim 6 wherein the gate separating the yard area and the grazing area is automated and opens and closes at predetermined times.

10. The chicken house of claim 6 wherein the grazing area is of sufficient dimensions to allow for a minimum of sixty square feet per chicken contained within the chicken house.
